(19) United States
(12) Patent Application Publication
(10) Pub. No.: US 2004/0172317 A1
(43) Pub. Date: Sep. 2, 2004

(54) System for improving processes and outcomes in risk assessment

(76) Inventors: Nancy J. Davis, Evanston, IL (US); Steven Ira Kauderer, Englewood, NJ (US); Gail E. McGiffin, Summit, NJ (US); Rose Mary Ciraulo, Harding Township, NJ (US); Kathleen Ziegler, Chicago, IL (US); Anthony G. Tempesta, Falls Church, VA (US)

Correspondence Address: BRINKS HOFER GILSON & LIONE, P.O. BOX 10395, CHICAGO, IL, 60610, US

(21) Appl. No.: 10/299,960

(22) Filed: Nov. 18, 2002

(51) Int. Cl. G06F 17/60

(52) U.S. Cl. 705/7

(57) ABSTRACT

A risk analysis system that takes an outcome oriented approach to analyzing risk assessment, training risk assessors as to best practices for assessing risk, and enabling monitoring of compliance with the best practices (the “System”) is presented herein. The goal of the System is to determine compliance of risk assessment processes with best practices in the past and into the future using various performance measures such as economic gain and lost cost opportunities, identify in which phase of the risk assessment life-cycle these performance measures are the greatest, and focus improvement, training and monitoring efforts on these risk assessment phases using a hands-on-based approach. The System includes a group of procedures, methodologies, questionnaires, software, hardware and analyses to analyze risk assessment processes by developing or improving best practices, providing training as to the best practices, and enabling the monitoring of compliance with the best practices.

### BACKGROUND

For entities (including businesses, companies and individuals) such as those that issue insurance or grant loans and/or leases, assuming risk is an unavoidable part of doing business. An absolute necessity for such entities is the ability to effectively and efficiently assess risk (“risk assessment”). Risk assessment involves not only determining the nature and extent of the risk but also the potential for profit gained by assuming the risk.

For entities involved in any type of risk assessment, it is crucial to have well trained people to make the risk assessments (“risk assessors”) and to monitor, analyze and update any processes used by the risk assessors for risk assessment (“risk assessment processes”). Known audits are generally conducted either manually or by using a system which can only determine basic information including the number of risk assessments made, the risk assessors that performed the risk assessment, the amount charged to assume the risk (such as a premium, interest or fee) and the time frame for the risk assumption. Unfortunately, this type of information is not sufficient to determine whether risks are being assessed in an efficient and cost effective manner. There are limited means to determine whether an entity is effectively assessing risk, however, these limited means tend to be costly and time consuming. Further, it is difficult to calculate whether risk assessors are using the best methods for streamlining the risk assessment processes. To compound this problem, risk assessors generally receive only on-the-job training and perhaps a limited amount of formal introductory training. Furthermore, this training generally focuses on the processes and procedures to be used and regulations to be followed rather than on obtaining a financially viable outcome.

As such, there is a need for a system which can review risk assessment processes more completely in order to provide information that can be used to determine which processes are beneficial, whether the consideration received for assuming the risk is appropriate, and whether risks are being handled efficiently and effectively.

### SUMMARY

Presented herein is a system that takes an outcome oriented approach to analyzing risk assessment, training risk assessors as to best practices for assessing risk, and enabling a quality assurance process (the “System”). The goal of the System is to determine performance measures such as economic gain opportunities in risk assessments, identify in which phase of the risk assessment life-cycle these performance measures are the greatest, focus improvement and training efforts on these risk assessment phases using a hands-on-based approach, and use the performance measures to monitor compliance with the best practices associated with these risk assessment phases in the past and into the future. The System includes a group of procedures, methodologies, questionnaires, software, hardware and analyses to analyze risk assessment processes by providing a view of the current state of risk assessment processes, developing or improving best practices, providing training as to the best practices and enabling the monitoring of compliance with the best practices.

The methods included in the System generally include, performing a risk data analysis procedure (“RDAP”), conducting a best practices training, and enabling a quality assurance process. The RDAP uses information relating to risk assessment processes and evaluates this information in terms of the life cycle or phases of risk assessment. The RDAP includes the steps of preparing for the RDAP, conducting the RDAP to generate quantitative analyses and qualitative results, and generating reports which include recommendations and suggestions for improvement based on the quantitative analyses and the qualitative results. To begin the implementation of the improvements and recommendations suggested by the RDAP, best practices training is conducted. Conducting the best practices training includes an outcome focused learning approach used to instill a results orientation for risk assessment. More specifically, conducting the best practices training includes providing hands-on training for best practices; providing content expert presentations; providing networking opportunities; providing feedback and improvement mechanisms; and enabling the determination of best practices. Enabling a quality assurance process that allows the monitoring of compliance with the best practices after the RDAP has been completed includes developing a framework, developing a quality assurance database, and conducting a scoring process.

Portions of the RDAP and the quality assurance process may be implemented as software, and in a risk analysis device. More specifically, portions of the RDAP may be implemented as risk analysis software which provides an automated implementation of the procedure for determining the quantitative results, generating recommendations and generating reports. Portions of the quality assurance process may be implemented as quality assurance software which provides an automated implementation of the process for providing conducting a scoring process. The procedures for generating the quantitative results and conducting a scoring process may be implemented in a risk analysis device. The risk analysis device generally includes a risk analysis unit and may also include an interface unit.

### BRIEF DESCRIPTION OF THE DRAWINGS

Described herein are numerous embodiments, which will be understood by those skilled in the art, based on the present disclosure. Some of these are described below and are represented in the drawings by means of several figures, in which:

FIG. 1 is a flow chart of a method involved in the system for improving risk assessment processes and outcomes, according to the present invention;

FIG. 2 is a flow chart of a method for performing a risk data analysis procedure, according to the present invention;

FIG. 3 is a flow chart of a method for preparing for the risk data analysis procedure, according to the present invention;

FIG. 4 is a flow chart of a method for conducting the risk data analysis procedure, according to the present invention;

FIG. 5 is a flow chart of a method for conducting the quantitative portion of the risk data analysis procedure, according to the present invention;

FIG. 6 is a flow chart of a method for generating the reports of the risk data analysis procedure, according to the present invention;

FIG. 7 is a flow chart of a method for providing training for best practices;

FIG. 8 is a flow chart of a quality assurance process;

FIG. 9 is a flow chart of developing a framework; and

FIG. 10 is a block diagram of a risk data analysis device.

### DETAILED DESCRIPTION

A system for improving processes and outcomes in risk assessment (the “Risk Data Analysis System” or the “System”) includes a group of procedures, methodologies, questionnaires, software and analyses used to analyze risk assessment processes in order to improve the risk assessment processes by providing a view of the current state of the risk assessment processes, developing or improving best practices, providing training as to the best practices, and enabling the monitoring of compliance with the best practices.

The System takes an outcome oriented approach to analyzing risk assessment processes. The goal of the System is to identify economic gain opportunities (“EGO”) in risk assessment, identify in which phase of the risk assessment life-cycle (“risk assessment phase” or “phase”) EGO exists and focus improvement, training and monitoring efforts on these risk assessment phases. In general, EGO is a measure of leakage and is determined for each risk assessment phase and represents the revenues lost and losses incurred in these phases due to inefficient practices. Therefore, the risk assessment phases that have a higher EGO will be identified and targeted for improvement during a best practices training and for future monitoring using a quality assurance process.

Because risk assessment processes tend to coincide with the risk assessment phases, the System analyzes the risk assessment processes in terms of each risk assessment phase in order to identify improvement opportunities in the risk assessment processes. This enables an evaluation of how well the individual risk assessment processes yield profitable outcomes and how well they are executed.

In general, risk assessment goes thru at least six (6) risk assessment phases. The first phase involves identifying exposures. This is the phase in which all the risks that might be encountered in a particular case are identified. The second phase, evaluating exposure, involves determining the likelihood that the exposures will become actual losses and the potential extent of the actual losses should they occur. In some embodiments, the second phase may be combined with the first into a single phase. The third phase involves making the risk decision. In this phase, a decision is made based on the results of the second phase regarding whether to assume the risk. If during the third phase it is decided that the risk will not be assumed, the life-cycle of the risk assessment process stops at the end of the third phase. However, if the risk is assumed in the third phase, the life-cycle continues with the fourth phase, setting the terms and conditions. Setting the terms and conditions involves determining the details under which the risk will be assumed. These details may include, the duration of the risk assumption, the duties of the entity from which the risk will be assumed, the precise definition and scope of the risk assumption and any other term except price. Setting the price for which the risk will be assumed is generally done separately in the fifth phase (because the price depends in part on the particular terms and conditions under which the risk will be assumed. The next phase is negotiation. In this sixth phase, the set terms and conditions and/or price may be adjusted in order to make them acceptable and so that a risk relationship is established.

Additionally, in some cases a seventh phase is also included. This seventh phase, setting the service program, involves determining the effectiveness of any service resources that were used. Service resources are internal and external services that may be used to evaluate, mitigate or otherwise respond to different aspects of a risk and generally include loss control, claims and premium audits. Loss control audits involve assessing risks and exposures before and/or after a risk has been assumed. Premium audits, which may also include interest or fee audits, generally involve either a voluntary or a physical audit of a business that is or will be the subject of a risk policy (such as the insured operation covered by or to be covered by an insurance policy or the collateral for a loan) to see if the premium, interest and/or fees charged were the proper amount based on the assumptions made by the risk assessor. Additionally, there may be risk assessment specific service resources such as claim audits and default audits. For example, if the risk assessment is underwriting, an additional service resource may be claim audits. Claim audits generally involve special handling of claims made under an insurance policy, which is a costly procedure. In another example, if the risk assessment is lending, an additional service resource may be default audits. Default audits generally include determining the circumstances under which there is a default on a loan repayment. The effectiveness of any service resources that are used is evaluated by determining the over or under utilization of those service resources. Over utilization of a service resource occurs when that service resource is used beyond the point where its use produces a monetary savings or measurable improvement. Under utilization occurs when a service resource is not used in situations where its use would have produced a monetary savings or loss cost impact. Although this phase is the seventh phase, it applies to the use of service resources before and/or after a risk is assumed.

Because many entities involved in risk assessment have large and complicated organizations, the System can analyze risk analysis along various dimensions (“analysis dimensions”). These analysis dimensions include line of business, geographic location, type of risk assumed, branch, division, office or any other dimension along which analysis is desired. For example, an entity may want to compare the performances of each of its branch offices in terms of the type of risk they assume. In this case, the System would analyze the risk assessment in terms of the office and type of risk dimensions by determining the EGO for each branch office for each of the types of risk they assess.

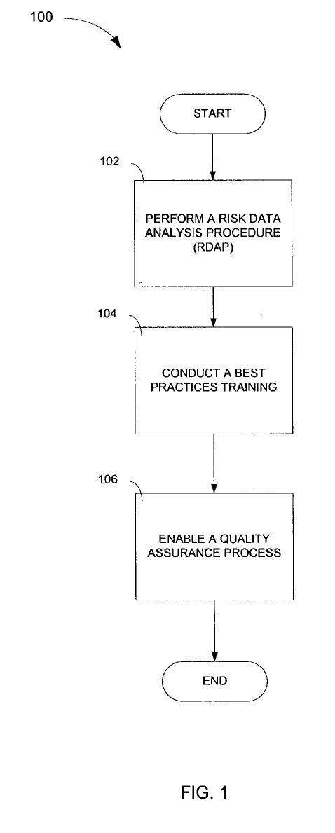

In one sense, the System can be considered a “toolkit” which includes a collection of “tools” or components that can be used in many combinations to analyze risk assessment processes. It is convenient to group these tools as follows: the risk data analysis procedure; the recommendation the best practices training; the quality assurance process, the risk analysis software, the quality assurance software, and the risk analysis device. These groups of tools can be used separately and the individual tools within these groups can also be used separately. However, when used in combination with each other, a highly effective analysis can be obtained. One example of the methods included in the System as they are used in combination is shown generally in FIG. 1 and indicated by reference number 100. The methods in the System generally include, performing a risk data analysis procedure or RDAP 102, conducting a best practices training 104, and enabling a quality assurance process 106.

Risk Data Analysis Procedure

The risk data analysis procedure (“RDAP”) uses information relating to risk assessment processes and evaluates this information in terms of the risk assessment life-cycle. The results of the RDAP provide a clear scorecard regarding the quality of risk assessment processes in terms of the accepted standards used by the risk assessment industry (collectively the “industry standards”) and identify and prioritize opportunities for improvement. In general, information is obtained from documents in files relating to individual risk assessment cases, such as the loan-related documents in a loan file for a specific loan for a particular customer or the underwriting-related documents in an underwriting file for a specific insurance policy for a particular client. The industry standards used are those that apply generally to the risk assessment industry and can be customized to include the industry best practices relating specifically to the type of risk assessment being analyzed (the “customized industry best practices”). To optimize the effectiveness of the RDAP, the risk analysis software and the risk analysis device can be used to help implement the RDAP.

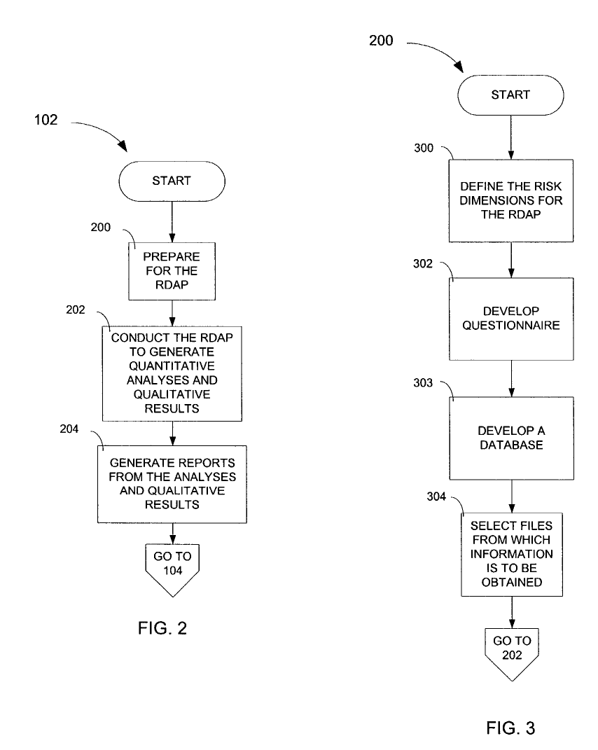

The RDAP 102 is shown generally in FIG. 2 and includes preparing for the RDAP 200, conducting the RDAP to generate quantitative analyses and qualitative results 202 and generating reports from the quantitative analyses and the qualitative results 204. Preparing for the RDAP 202 is shown in more detail in FIG. 3 and generally includes defining the analysis dimensions for the RDAP 300, developing a questionnaire 302, developing a database 303, and selecting files from which the information is to be obtained (the “selected files”) 304. As previously discussed, the analysis dimensions are used to categorize the information used for the RDAP and the results generated by the RDAP into groups that provide insights into the desired segments of a risk-assessing entity. Although the analysis dimensions may be pre-defined and static from one RDAP to another, it is more useful to define the analysis dimensions for each RDAP so that the results are customized for the particular entity involved. Additionally, the analysis dimensions may be further broken down into subgroups. Using subgroups helps to demonstrate specific problem areas within each of the analysis dimensions. Examples of analysis dimension subgroups include geographic area of the risk, policy or loan duration, degree of risk involved, resources used in risk assessment, types of liability, external and internal data sources used in risk assessment, number of claims or defaults made, uniformity of the information used and overlooked exposures.

Once the dimensions for the RDAP are defined, a questionnaire is developed 302. This questionnaire is used to elicit information from the selected files so this information can be used to create quantitative analyses and to determine compliance with the industry best practices and/or the customized best practices during the RDAP. The questionnaire may be a form questionnaire, a customized questionnaire or a partially customized questionnaire. A form questionnaire generally includes standard questions applicable to most risk analysis situations including questions designed to elicit information used to determine compliance with industry best practices and is not altered for any particular RDAP. A customized questionnaire is developed for a particular RDAP and includes questions that use the particular terms and language of and elicit information that is particular to the entity for which the RDAP is to be performed. Additionally, the customized questionnaire includes questions designed to elicit information used to determine compliance with the custom best practices. However, the questionnaires may also be partially customized in that, although they use standard questions for each RDAP, the language is altered so that entity-specific jargon or terminology is used and questions are added to elicit information specific to the entity being analyzed and to determine compliance with the customized and/or industry best practices. For entities outside the United States, significant amounts of customization are generally required because the types of relevant information are most likely going to be different.

Whether the questionnaire is developed as a form questionnaire, a customized questionnaire, or a partially customized questionnaire, the questionnaire is designed to elicit information relating to the risk assessment phases. Table 1 shows an example of questions that may be included in the questionnaire according to the risk assessment phase from which they are designed to elicit information.

TABLE 1

| | |
|---|---|
| Phase 1 - Identify | What are the risks? |
| Exposures | What information was collected for analyzing the |
| | risks? |
| | What are the exposures? |
| | Were all the exposures identified? If not, which |
| | exposures were missed? |
| | What were the entity's losses? |
| Phase 2 - Evaluate | Where all the critical exposures evaluated? |
| Exposures | Which critical exposures were not evaluated? |
| | What techniques were used to control or mitigate |
| | the exposures and were these techniques |
| | effective? |
| Phase 3 - Make | Did the decision comply with written guidelines |
| the Risk Decision | or was making an exception to the guidelines |
| | acceptable? |
| | Did the decision comply with industry best |
| | practices? |
| | Was the decision within the risk analyzer's |
| | authority? |
| | Was the decision correct? |
| | If the decision was not correct, would any |
| | modifications have made a difference? |
| | If the risk was declined, what was the premier |
| | factor that should was considered? |
| Phase 4 - Set | Was the risk to be assumed standard? |
| the Terms and | Was information incorrect or missing from the |
| Conditions | terms and conditions? |
| | Were the deductibles and/or sub-limits sufficient |
| | to mitigate the risk involved? |
| Phase 5 - Setting | Was the base rate appropriate for the type of risk |
| the Price | assumed? |
| | How was price determined? |
| | What influenced pricing? |
| Phase 6 - Negotiation | Was there competition? |
| | Was there negotiation? |
| | What were the competing quotes? |
| | What changed due to the negotiation? |

Some of these questions are used to determine compliance with the customized and/or industry best practices related to each of the phases. In addition to the questions that directly ask if there was compliance with best practices, questions such as: “Have all exposures been identified?” and “If not, what exposures were missed?” may also be used to determine compliance with best practices. Additionally, the questionnaire will generally include questions designed to elicit a determination of performance measures for each of the phases. Questions, such as these, will be included in the questionnaire. The questionnaire may provide space for answers to be written in or it may provide a group of possible answers from which to choose. The questionnaire can be in written, oral, digital, analog or any other form capable of eliciting the needed information. One example of an embodiment of a digital questionnaire and a system for capturing answers including, data storage, analysis and reporting capabilities is described by Costonis et al. in the commonly-owned co-pending U.S. patent application Ser. No. 09/559,725, filed Apr. 28, 2000, entitled “claim Data Analysis Toolkit,” which is hereby incorporate by reference in its entirety.

The next step in preparing for the RDAP 200 (FIG. 2) is developing a database 303 to store the information elicited using the questionnaire. The database 303 may also store the RDAP software, quality assurance software, customized and/or industry best practices, recommendations and/or the questionnaire. The database may be developed prior to the RDAP process and modified after or at the same time that the questionnaire is developed or the files are selected so that it will be able to store any information elicited by customized questions. Alternatively, the database may be developed entirely at any of these points. The database will generally have two portions, a storing portion and an analyzing portion. The storing portion will store the reports, the quantitative analyses, the qualitative results, the recommendations and any other needed information or data. The analyzing portion includes the risk data analysis software which uses the quantitative analyses and the customized and/or industry best practices to generate quantitative results and reports from the qualitative and quantitative results. As part of the risk data analysis software, the analyzing portion also includes a recommendation generator that generates recommendations based on the quantitative results. The structure of the database can be totally custom-developed or developed within the framework of existing database software such as, Microsoft Access.

Defining the analysis dimensions for the RDAP 300 and developing the questionnaire 302 generally defines the information needed to conduct the RDAP. Considering this, the files from which the needed information is to be obtained in order to produce the analyses are selected 304. The number of files selected must be a number sufficient to yield statistically significant data. In general, to fulfill this requirement, at least 8-10% of the relevant files in an entity's books are selected. Generally, files are selected that are representative of all the files in an entity's books. However, files representing exceptional activities may also or alternatively be chosen.

Selecting the files 304 may involve a four (4) step process. In the first step a performance report is generated to provide a summary of the profits and losses of the entity along a desired dimension or dimensions. For example, the performance report may be generated by division to provide a macro view of the relative performance of the different divisions. In the second step, an account run is performed. The account run includes preparing an inventory of accounts and/or policies in the dimensions for which problem areas were made evident in the first step. Using this inventory of accounts, the files corresponding to some of the accounts and/or policies listed in the inventory are reviewed manually to identify groups of files with the desired properties or information. This helps to direct the file selection 304 to files that represent areas that are typical or of particular interest. The results of this step may be summarized in a report of the books. One possible result may be that certain file types are identified for selection. Generally, the types of files that are identified for selection depend, in part, on the type of risk assessment involved. For example, when the risk assessment involves underwriting for an insurance policy, new or renewal underwriting files and their associated claim histories may be identified because they can be used to analyze the current underwriting effectiveness and efficiency. Submissions for coverage for which coverage was applied and a quote given but for which no agreement was reached, may also be selected for the same purpose. Additionally, submissions for coverage for which coverage was applied and denied and submissions which were submitted to competitors may be selected because they can be used to assess alignment with producers and to identify potential growth areas.

In the second step of selecting the files from which information is to be obtained 304 is the calibration step. This is the step in which the individual files are selected or “pulled.” This step, as well as the first step, generally needs to be done manually because the files are primarily in hard copy form. However, if the files are in an electronic format, the files may be reviewed and calibrated electronically using any one of a number of known search routines. Once selected, the files are designated as “selected files” and are then used to conduct the RDAP.

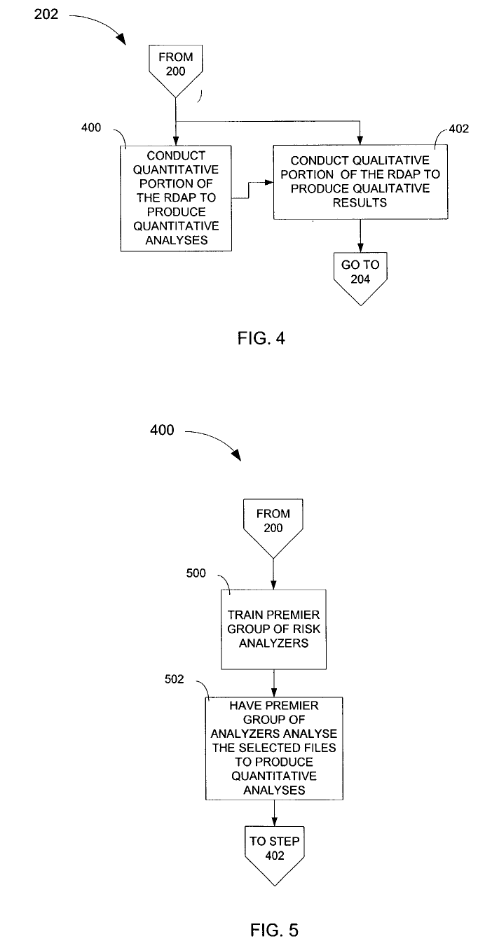

The step of conducting the RDAP to generate quantitative analyses and quantitative results 202 is shown in more detail in FIG. 4. Conducting the RDAP 202 generally includes conducting a quantitative portion of the RDAP to produce quantitative analyses 400 and conducting a qualitative portion of the RDAP to produce qualitative results 402. The quantitative and the qualitative portions are conducted in parallel. Alternately, the qualitative portion may also be conducted in parallel with and after the quantitative portion (as shown in FIG. 4) so as to take into account the quantitative analyses produced in the quantitative portion.

As shown in FIG. 5, conducting the quantitative portion of the RDAP 400 includes training a premier group of risk assessors 500 and having the group of premier risk assessors analyze the selected files to produce quantitative analyses 502. Training a group of premier risk assessors 500 includes choosing the group of premier risk assessors and training and synchronizing the group of premier risk assessors. The group of premier risk assessors generally includes the best or top risk assessors (the “premier assessors”) working for the entity for which the risk analysis is being performed. The premier assessors are chosen to analyze the selected files because they are the individuals that know their entity's risk assessment processes best. Furthermore, using risk assessors from within the entity being analyzed as part of the RDAP, helps to initiate the best practices training.

Training a premier group of risk assessors 500 also includes training and synchronizing the group of premier risk assessors. Training and synchronizing includes training the entire group of premier risk assessors as to how to analyze the selected files while all the premiere risk assessors are in a single group and then having the premier risk assessors evaluate at least one example file. The example files used in training and synchronization may be chosen from the selected files, from the entity's books or may be pre-developed files. The group of premier risk assessors is then broken down into at least two subgroups and the training and synchronization procedure is repeated as before except that each subgroup evaluates at least one additional example file. The analyses performed by each subgroup are then compared with each other. If the analyses are not consistent with each other, the training is repeated until the analyses are consistent. If the analyses are consistent with each other, the subgroups are broken down into progressively smaller subgroups of the premier group. The training and synchronization continues until the risk assessors have been trained individually and the results of their individual analyses are consistent throughout the group of premier risk assessors.

The quantitative portion of the RDAP 400 continues with having the group of premier risk assessors analyze the selected files to produce quantitative analyses 502. All the risk assessors in the premier group individually analyze at least one selected file from the point of view of a risk assessor by completing the questionnaire for the selected files. This involves eliciting general information from the selected files and judging what was done in the file in terms of certain performance measures for the first through the sixth risk assessment phases.

In completing the questions in the questionnaire, the premier assessors will generally determine a value for at least one performance measure for each phase and provide a reason for the particular value obtained. The performance measures are generally types of EGO which include, lost cost avoidance, expenses, premium and Price Differential. Generally, the questionnaire will include questions that ask the premier risk assessors to determine the corresponding performance measure for each phase. Additionally, the questionnaire will ask the premier risk assessor to evaluate the value obtained for the performance measure. Table 1 shows one example of performance measures that may be used for each of the risk assessment phases and how these performance measures may be determined:

TABLE 2

| | | PERFORMANCE | HOW PERFORMANCE MEASURE |
|---|---|---|---|
| PHASE | LOSS | MEASURE | DETERMINED |
| Phase 1 | Loss in Identifying | Loss cost avoidance | Loss cost avoidance = (actual losses |
| | Exposures | (“LCA”); | due to unidentified and misidentified |
| | | Premium | exposures) + IBNR |
| | | | Premium = (what should have been |
| | | | charged for unidentified or |
| | | | misidentified exposures) |
| Phase 2 | Loss in Assessing | LCA; | Loss cost avoidance = (actual losses |
| | Exposures | Premium | due to misassessed or unassessed |
| | | | exposures) + IBNR |
| | | | Premium = (what should have been |
| | | | charged if properly assessed) |
| Phase 3 | Loss in Making the Risk | LCA; | Loss cost avoidance = (actual losses + IBNR) |
| | Decision | Expenses | for risks that should not |
| | | | have been assumed |
| | | | Expenses = (expense costs incurred |
| | | | for handling risk that should not have |
| | | | been assumed) |
| Phase 4 | Loss in Setting the Price | Premium | Gross leakage = (what should have |
| | | | been charged) − (what was charged) |
| | | | Net leakage = (propensity factor) × (Gross |
| | | | Leakage) |
| Phase 5 | Loss in Setting the Terms | LCA; | Loss cost avoidance = (actual loss |
| | and Conditions | Premium | dollars paid due to specific terms |
| | | | and/or conditions that were |
| | | | inappropriately set or never set at all) |
| | | | Premium = (what should have been |
| | | | charged for term or condition) |
| Phase 6 | Loss in Negotiating | LCA; | Loss cost avoidance = (loss dollars |
| | | Price Differential | incurred due to specific terms that |
| | | | changed during the negotiation |
| | | | process) |
| | | | Price differential = (price quoted) − (price |
| | | | negotiated) |

LCA is a measure of leakage due to the loss of a cost avoidance opportunity. In Phase 1, associated with every exposure that is identified is the opportunity to reduce costs due to that exposure. For example, if the risk assessment is lending, one possible exposure is that the collateral for the loan may be easily destroyable. If this exposure is identified, the lender has the opportunity to require the borrower to take out insurance on that collateral. However, for each exposure that is not identified the opportunity to reduce costs associated with the unidentified exposure is lost. LCA is generally defined by the equation:

Loss cost avoidance=(actual losses incurred)+IBNR (1)

Wherein IBNR (or incurred but not reported) represents incurred and anticipated losses that have not been recorded. With regard to Phase 2, the LCA measures the ability to avoid a claim or a default due to improperly assuming a risk. In both Phases 1 and 2, the LCA is an exposure-specific performance measure and is determined using Equation (1). For Phase 3, LCA represents the loss of a cost avoidance opportunity due to improperly assuming or rejecting the assumption of a risk. LCA for Phase 3 includes all such losses, independent of exposure and is determined using Equation (1)

In contrast, the performance measure for Phase 4 is premium. Premium may be determined in terms of gross leakage or net leakage. In Phase 4, Gross Leakage is a measure of loss that results from charging an insufficient premium, fee and/or interest rate. Gross leakage is generally is defined according to the equation:

Gross Leakage=What should have been charged−what was charged (2)

Net leakage is also a measure of this loss. However, it takes into account a propensity factor “p”.

Net leakage=Gross Leakage×p (3)

The propensity factor is a value less than or equal to one that represents the likelihood that the sufficient premium, fee or interest rate would have been obtained. Also determined for Phase 4 is expenses which is a measure of leakage that represents the costs incurred by an entity on a risk that should not have been assumed. Finally, premium is a measure of leakage that represents the fees, interest and/or premiums that were not obtained due to an incorrect assessment.

Additionally, losses in Phase 7, setting the service program, may also be determined. The loss measures in this phase are a function of the under or over utilization of any service resources. When any service resources are over utilized, the performance measure used is expenses because the amount of money spent on service resources that had no monetary impact on the risk account represents an unnecessary expense. In contrast, when service resources are under utilitzed, the performance measure is loss cost avoidance because the EGO in this situation will be due to exposures that most likely would have been discovered or mitigated if the service resources were properly utilized. If this phase is included, the questionnaire will include questions designed to elicit information relating to service resources such as: “In accordance with best practices, should loss control been ordered to better identify exposures?”

Conducting the qualitative portion of the RDAP 402 (shown in FIG. 4) is done to help identify particular problem areas in the risk assessment procedures used by the entity and to help develop best practices that will improve these risk assessment procedures. Generally, conducting the qualitative portion of the RDAP 402 includes interviewing risk assessors and holding focus groups for risk assessors. The interviews are generally conducted with risk assessors that may or may not belong to the group premier risk assessors. The interviews ask questions of the risk assessors to determine what the risk assessors think they do, and the resources and thought processes used by the risk assessors in terms of EGO. The focus groups are facilitated interviews with groups of risk assessors during which suggestions for best practices are elicited and developed by the group. This qualitative portion of the RDAP 402 is generally done in parallel with the quantitative portion 400. However, for even better results, the qualitative portion can be done again after the quantitative portion so that the interviews can be targeted towards the risk assessment phases or the analysis dimensions of concern as indicated by the quantitative portion.

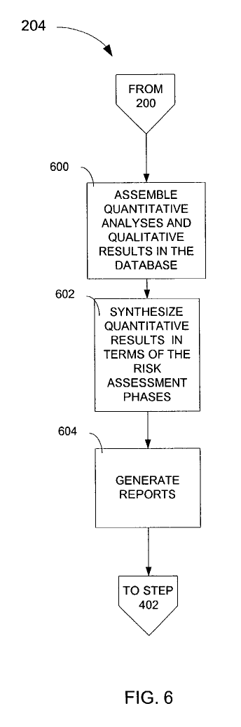

As shown in FIG. 2, the results of the quantitative and qualitative portions of the RDAP are used to generate reports. The step of generating reports 204 is shown in more detail in FIG. 6 and generally includes assembling the qualitative analyses and the quantitative results in a database 600; synthesizing quantitative results in terms of the risk assessment phases 602; and generating reports 604. Assembling the qualitative analyses and the quantitative results in a database 600 includes entering the qualitative analyses elicited through use of the questionnaire and the quantitative results into the database. The database stores this information by categories such as, the identity of the premier risk assessor that analyzed the file and by risk type so that the data may be retrieved in any number of ways. Entering the quantitative results and the qualitative analyses into the database may be accomplished by any number of known methods including, typing the information on a keyboard and scanning the information and using character recognition software to convert the scanned images into text-based documents.

Alternatively, the step of assembling the qualitative analyses and the quantitative results in a database 600 may be done simultaneously with the step of having the group of premier risk assessors analyze the selected files 502 (shown in FIG. 5) by having the group of premier risk assessors input their quantitative analyses directly into the database. In another embodiment, the group of premier risk assessors input their quantitative analyses directly into the database by providing responses to the questionnaire which is also implemented in the database. When the questionnaire is implemented in the database, it can be done so that only the questions relevant to a particular RDAP are shown to the premier risk assessors, thereby automatically skipping irrelevant questions. Furthermore, the questionnaire can perform a feasibility check of the responses to the questions and not allow the premier risk assessor to go on to the next question if an error in the current response is discovered. This helps to ensure consistency and accuracy of the quantitative analyses.

Synthesizing quantitative results in terms of risk assessment phases 602 includes aggregating the values for the performance measures for each analysis dimension and for the entity as a whole. These aggregate values, along with the quantitative analyses make up the quantitative results. This step may be automated by the database itself. Once the quantitative results are generated, they are stored in the database. The values of the quantitative results are then evaluated by a recommendation generator to determine if the values are within the range of any of the recommendations. The recommendation generator then generates the appropriate recommendation for each quantitative result that has a value that falls within the scope of that recommendation. Once the quantitative results and the recommendations have been generated, they are then, together with the results of the qualitative portion of the RDAP (the qualitative results), compiled into at least one report. Generating reports 604 includes presenting various aspects of the quantitative and qualitative results and the recommendations in a manner that is easier to understand than the quantitative and qualitative results themselves. The data included in the reports may be presented in graphical form, but may also be presented as textual listing. The information contained in these reports can be assembled in any manner and in any combination and may also include an analysis of the quantitative and qualitative results. The following represents merely a sample of the possible reports that may be generated using the quantitative results and the results of the qualitative analysis: an Executive Summary, a Risk Analysis Data Analysis Report; and Final Recommendations.

An Executive Summary generally contains an overview of the quantitative results terms of the risk assessment phases, the qualitative results, the major problems identified and some recommendations as to solutions to these problems. The quantitative results to be included in the overview are generally selected manually and include the quantitative results that best represents the current state and illustrates the problems of the risk assessment processes that were analyzed. The quantitative results are not only presented in terms of the risk assessment phases, but along the selected analysis dimensions. Additionally, the qualitative results are included. The qualitative results are used to interpret the quantitative results to help identify the problems and suggest the solutions that are likely and/or unlikely to be successful in solving the problems. Additionally or alternatively, the qualitative results selected for inclusion in the Executive Summary may include those qualitative results which represent the current risk assessment procedures that are effective which, when interpreted using the qualitative results, suggest procedures that are effective and should be maintained. The recommendations may be prioritized based on phases that will show the greatest rate of return if the results were improved. Additionally, the recommendations may be quantified by the of dollar amounts that could be saved if the recommendations were implemented. For example, one recommendation may be to stop assuming certain types of risks in certain geographic locations due to irreparable losses.

The Risk Data Analysis Report includes a summary of the selected files reviewed during the RDAP and the results of RDAP. Also included in this report are various aspects of the quantitative results presented along the analysis dimensions and in terms of the risk assessment phases. For example, the Risk Data Analysis Report may present the data in terms of the EGO or the EGO per share of the fee or premium received. However, the quantitative results may also or alternatively be presented in terms of LCA and/or Price. Which of the quantitative results are and how they are presented is generally determined manually from an inspection of the quantitative results along the various analysis dimensions. A sample of some of the analysis dimensions by which the EGO and EGO per share of fee or premium received may be presented include: geographic area of the risk, policy or loan duration, degree of risk involved, resources used in risk assessment, types of liability, external and internal data sources used in risk assessment, number of claims or defaults made, uniformity of the information used and overlooked exposures. In addition to presenting the quantitative results in terms of EGO or EGO per share of fee or premium received, general information relating the selected files may also be presented such as: which of the selected files were missing information or had erroneous information; competitor information; whether the pricing is aligned with an existing guidelines, prices charged, number of quotes given and if terms and conditions were refined during negotiation. The quantitative results may be presented in any number of different ways limited only by the analysis dimensions chosen and the information elicited from the selected files.

The Final Recommendations is a report that includes a prioritized list of the recommendations and a timeline for implementing these recommendations. The recommendations are listed in terms of which recommendation has the greatest potential to increase performance measures. Recommendations are determined based on the findings of the RDAP and may be generated manually or automatically. Examples of recommendations include pricing training, producer management training, industry or line of business training, what reports to order for information gathering and the best practice tools to use to assess exposures. In some cases, recommendations are made that can be quickly implemented that will generate a good size return.

Best Practices Training

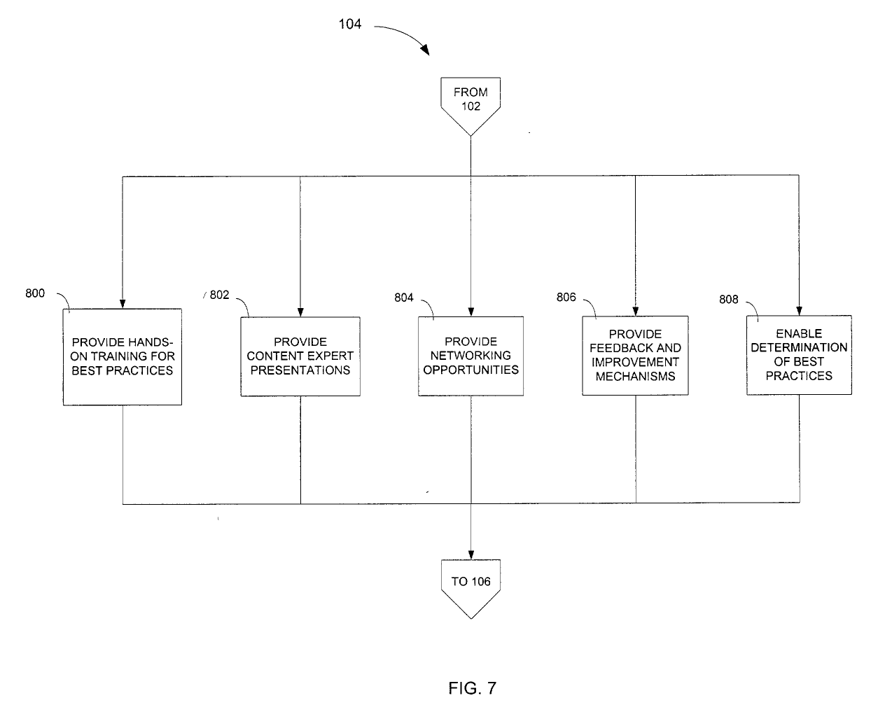

To begin the implementation of the results and recommendations suggested by the RDAP, best practices training is conducted. This best practices training extends the training received by the group of premier risk assessors in the RDAP to other risk assessors in the entity. Conducting the best practices training 104 shown in FIG. 1 is shown in more detail in FIG. 7 and includes an outcome focused learning approach to instill a results orientation for risk assessment. Instead of simply training risk assessors to blindly follow standards, the risk assessors are taught the manner in which their decisions and actions have a real and tangible effect on the profitability of their entity and are enabled to help define the best practices for risk assessment that their entity will adopt. During the best practices training, all or most of an entity's risk assessors that were not part of the group of premier risk assessors (the “remaining risk assessors”) are trained with regard to how the RDAP was conducted and the results of the RDAP including the recommendations. Then using the recommendations as a starting point, the remaining risk assessors participate in preparing best practices for risk assessment that their entity will adopt. The training may be focused specifically on the risk assessment phases determined during the RDAP to have the greatest EGO.

Conducting the best practices training 104 includes providing hands-on training for best practices 700; providing content expert presentations 702; providing networking opportunities 704; providing feedback and improvement mechanisms 706; and enabling the determination of best practices 708. All of these portions of the best practices training may be conducted in any order. In general, learning is better facilitated when these portions are intermixed and spread out over a number of days.

The hands-on training is a type of experiential learning provided to improve the risk assessment processes and outcomes by training the risk assessors as to the best methods for rapidly changing behaviors. This type of training enables higher retention with regard to the RDAP and the RDAP results and shorter time to proficiency with regard to risk assessment.

Providing hands on training 700 generally includes having the remaining risk assessors analyze training files and participate in conferencing. Training files may include some of the selected files and/or composite files. Composite files may be created by combining facts from some of the selected files and/or may be totally or partially fabricated. Specific training files are chosen or created because they contain fact patterns that will emphasize the best practices, particularly those that, if implemented or improved, will yield the greatest gain in the performance measures. The remaining analyzers review the training files using a process similar to that Used by the group of premier risk assessors. Alternately, in one embodiment, the remaining analyzers do not go through the calibration process but instead review the training files in teams each consisting of a subgroup of the remaining analyzers. Each team identifies the positive and negative actions that took place for each risk assessment phase of the risk assessment in terms of the best practices. After the teams have completed their analyses, conferencing allows the teams to learn from each other. Conferencing involves open communication among all the remaining risk assessors from all the teams regarding the facts of some of the training files and the possible opportunities for improving the outcome of the training files. Each team presents their analyses, followed by a discussion among the remaining risk assessors. This discussion may be facilitated by a facilitator. Conferencing ends when all the teams come to a consensus with regard to the analyses.

Providing content expert presentations 702, providing networking opportunities 704 and providing feedback mechanisms 706 are all done to reinforce the hands-on training and to build the relationships that will enable the training to continue long after the hands-on training has ended. Providing content expert presentations 702 includes having experts in risk assessment make formal presentations on various risk assessment related topics. Generally, the risk assessment related topics will be presented within the context of the risk assessment phases. The experts may come from within the entity or from other sources. Providing networking opportunities 704 includes hosting team building activities, performing checkpoint exercises and hosting social events. These activities all help to build relationships among the risk assessors to provide for a lasting resource within the entity regarding risk assessment and improving risk assessment processes. Providing feedback and improvement opportunities includes providing surveys and question and answer sessions on a periodic basis throughout the best practices training. This enables the best practices training to be constantly improved and updated as it is performed.

Enabling the determination of best practices 708 allows the remaining risk assessors to part of the process whereby the best practices are determined and adopted. Generally, the best practices are determined through discussion among the remaining risk assessors, which continues until a consensus is reached regarding which practices will be adopted as the best practices. Using a discussion and consensus approach to determining best practices helps instill in the remaining risk assessors a sense of ownership that will help to ensure that the best practices will be integrated into the way their entity conducts business thereby promoting compliance with the best practices. Although determining the best practices may be enabled at anytime during the best practices training, it is beneficial to at least begin the determination after the remaining risk assessors have had some training regarding the RDAP and its results so that they have a clear picture of the current state of risk assessment in their entity. The remaining risk assessors may develop the best practices from existing entity practices, industry standard practices or entirely from scratch. If the remaining risk assessors develop the best practices from current entity or industry practices, it is beneficial for them to receive some training regarding the qualitative results and the recommendations so that they may use these as a starting point.

Quality Assurance Process

To help ensure that the best practices are followed even after the RDAP and best practices training is concluded, a quality assurance process should be enabled so that the quality of the risk assessment of files not analyzed during the RDAP and files reviewed during the RDAP that have since been updated can be monitored. In general, enabling a quality assurance process 106 (FIG. 2) includes developing a method for monitoring risk assessment that allows the risk assessors or others within an entity to monitor their own risk assessment processes. The quality assurance process allows the entity to review files and arrive at a quantitative scoring of the quality of the risk assessment, which in turn allows an entity to review the risk assessment at a granular or macro level for quick identification of where in the risk assessment processes there may be a lack of understanding or a problem with the best practices.

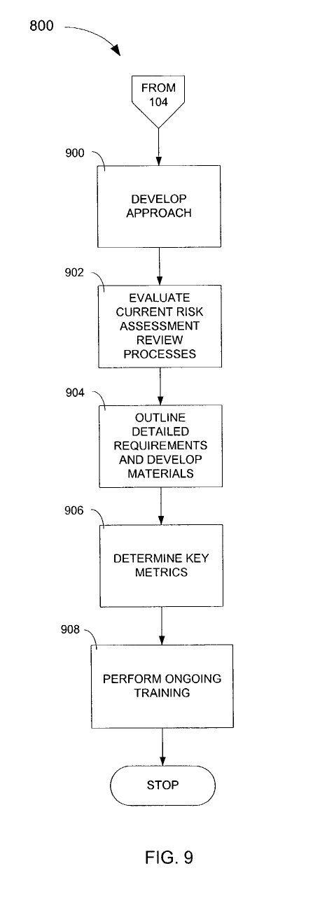

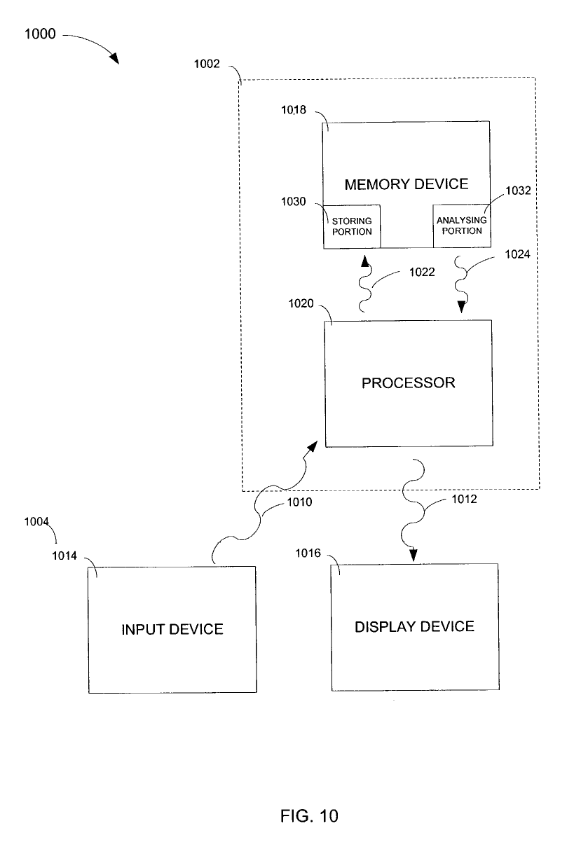

Enabling a quality assurance process 106 includes developing a framework 800; developing a quality assurance database 802; and conducting a scoring process 804. Developing a framework for the quality assurance process 800, as shown in FIG. 9, includes developing an approach 900; evaluating the current risk assessment review processes 902; outlining the detailed requirements and developing materials 804; determining key metrics 906 and beginning implementation and ongoing training 808. Developing an approach 900 generally includes developing the plan for enabling the quality assurance process. This plan is developed from the current state of the entity's risk assessment processes and the desired scope of the quality assurance process. In order to develop the plan, the current state of the entity's risk assessment processes, as determined in the RDAP, are confirmed. This helps define where the entity is in terms of its risk assessment which defines the baseline for improvement. Additionally, to implement the plan, the scope of the quality assurance process is defined. The scope may be defined to include all types of files, or only those that were identified as not conforming to best practices during the RDAP. Alternately, the scope may be defined in terms of line of business or in terms of any of the other dimensions for which the RDAP was carried out. The files or file types included in the scope will be the files or file types monitored by the quality assurance process. To complete the plan, a determination is made as to the resources that will be needed for the quality assurance process. These resources include the entity or other personnel needed to help perform the quality assurance process.

Evaluating the current risk assessment review processes 902 provides a view of the entity's current audit processes and uses the current audit processes as a baseline by which new audit processes are developed. The entity's current audit processes are the processes currently in use by the entity by which they determine the quality of their risk assessment. In some cases, current audit processes may not exist. This includes reviewing and documenting the current audit processes, including any forms, databases, questionnaires and other tools used by the entity in its current risk assessment review process. Using the entity's current risk assessment review process and the results of the RDAP (or only the results of the RDAP if no current risk assessment review process exists), a new risk assessment review process is developed. The new risk assessment review process may include all or only a portion of the recommendations developed during the RDAP.

Outlining the detailed requirements and developing materials 904 includes adapting the questionnaire used during the RDAP for use as an audit tool. This “audit questionnaire” is generally revised to reflect the scope of the new risk assessment review process and the results of the RDAP. For example, the questionnaire may be changed so that it only asks questions related to the first two phases of risk assessment for a particular geographic location. Additionally, outlining the detailed requirements may include determining the specific resources needed to perform the new risk assessment process such as the level and areas of expertise required of the personnel involved in this process.

Determining key metrics 906 includes determining the metrics by which files analyzed by the new risk assessment process is to be judged. Additionally, determining the key metrics 906 includes establishing baseline and target numbers for the key metrics. The baseline is the state of the risk assessment processes at the time of the RDAP or at some other defined time in the past. The state of the risk assessment processes is generally given in terms of the performance measures used in the RDAP. The target numbers are also generally given in terms of the performance measures and represent the desired state of the risk assessment processes. Further, determining key metrics may include establishing a reward or incentive program to reward risk assessors that help the entity meet its target for the key metrics. Performing ongoing training 908 includes training the resources to perform or help perform the quality assurance process.

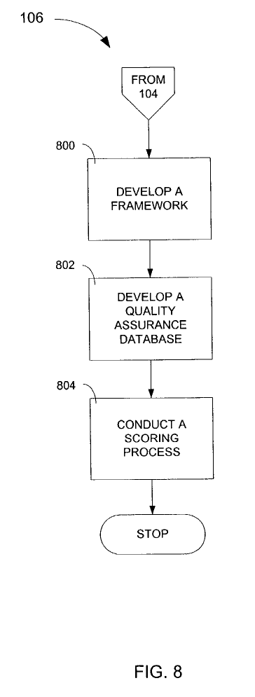

Referring to FIG. 8, once the framework is developed 800, a database is developed for the quality assurance process (the “quality assurance database”) 802. The quality assurance database is generally developed from the database used during the RDAP. However, it can be developed from almost any database structure. The quality assurance database is set up to store information within the scope and dimensions and for the performance metrics defined for the quality assurance process. The quality assurance database may also store the audit questionnaire.

Conducting the scoring process 804 is similar to conducting the quantitative phase of the RDAP. Questions from the audit questionnaire are answered by the resources and the answers are ultimately input into the quality assurance database. The audit process then uses the answers to compute one or more scores for the defined performance metrics. During the audit process, each file audited is evaluated in terms of how well it follows the best practices and recommendations established during the best training and the RDAP, respectively. The score gives a numerical measure of how well the best practices and recommendations were followed. In another embodiment, the score may be weighted, so that the scores generated for the performance metrics along defined dimensions may have greater weight (multiplied by a number greater than one) or a lesser weight (multiplied by a number less than one) than the scores along other non-weighted dimensions. The audit process also generates audit recommendations based on the scores for the performance metrics. The resource may then review the scores and recommendations and may add comments and other recommendations.

Risk Analysis Software

Some of the procedures used in the RDAP may be implemented in risk analysis software (“RAS”) and in score generating software (“SGS”). The RAS includes methods for generating the quantitative results, generating the recommendations, and generating the reports. The SGS includes methods for generating the scores for the performance metrics. Implementations and embodiments of the procedures for generating the quantitative results, generating the recommendations, generating the reports and for generating the scores for the performance metrics include computer readable software code. Although these procedures may be implemented manually, the automation provided by the RAS and the SGS improves the speed, accuracy and comprehensiveness of the RDAP and the enabling of the quality assurance process, respectively. These algorithms may be implemented together or independently. Such codes may be stored on a processor, or on a computer readable storage medium. Alternatively, these software codes may be encoded in a computer readable electronic or optical signal. The codes may be object code or any other code describing or controlling the functionality described herein. The computer readable storage medium may be a magnetic storage disk such as a floppy disk, an optical disk such as a CD-ROM, semiconductor memory or any other physical object storing program code or associated data.

Risk Analysis Device

The procedures for conducting the quantitative portion of the RDAP, generating the quantitative results, recommendations, reports and scores may be implemented in a risk analysis device as shown in FIG. 9 and indicated as reference number 1000. The risk analysis device 1000 generally includes a risk analysis unit 1002 and may also include an interface unit 1004. The risk analysis unit 1002 includes a processor 1020 coupled to a memory device 1016. The memory device 1016 may be any type of fixed or removable digital storage device and (if needed) a device for reading the digital storage device including, floppy disks and floppy drives, CD-ROM disks and drives, optical disks and drives, hard-drives, RAM, ROM and other such devices for storing digital information. The processor 1020 may be any type of apparatus used to process digital information. The memory device 1016 includes a storing portion 1030 and an analyzing portion 932. The storing portion 930 stores the quantitative analyses, the qualitative results and the quantitative results of the RDAP, the recommendations, the reports and may store the questionnaire. The analyzing portion stores the algorithms for determining the quantitative results, which is generally the risk analysis software. The risk analysis software includes a recommendation generator which generates the recommendations. Upon the relevant request from the processor 1020 via a processor signal 1022, the memory communicates the algorithm for determining the quantitative results and the quantitative analyses via a memory signal 1024 to the processor 1020. The processor 1020 then calculates the quantitative results from the quantitative analyses using the risk analysis software. Then, upon the relevant request from the processor 1020, the memory communicates the recommendation generator via a memory signal 1024 to the processor 1020 which generates the recommendations.

The interface unit 1004 generally includes an input device 1014 and an output device 1016. The output device 1016 is any type of visual, manual, audio, electronic or electromagnetic device capable of communicating information from a processor or memory to a person or other processor or memory. Examples of display devices include, but are not limited to, monitors, speakers, liquid crystal displays, networks, buses, and interfaces. The input device 1014 is any type of visual, manual, mechanical, audio, electronic, or electromagnetic device capable of communicating information from a person or processor or memory to a processor or memory. Examples of input devices include keyboards, microphones, voice recognition systems, trackballs, mice, networks, buses, and interfaces. Alternatively, the input and output devices 1014 and 1016, respectively, may be included in a single device such as a touch screen, computer, processor or memory coupled to the processor via a network. The quantitative analyses may be communicated to the memory device 1016 from the input device 1014 through the processor 1020. Alternatively, the interface unit 1004 may include a plurality of input and output devices 1014 and 1016, respectively, to enable a plurality of risk assessors or the group of premier risk assessors to enter the quantitative analyses directly into the input device. In another alternative, the quantitative analyses may be communicated from a memory device such as a CD-ROM disk and drive or from a network for in bulk to the memory device 1018 via the processor 1020. Additionally, the quantitative results may be communicated from the processor 1020 to the display device 1012.

Although the methods and apparatuses disclosed herein have been described in terms of specific embodiments and applications, persons skilled in the art can, in light of this teaching, generate additional embodiments without exceeding the scope or departing from the spirit of the claimed invention. Accordingly, it is to be understood that the drawings and descriptions in this disclosure are proffered to facilitate comprehension of the invention and should not be construed to limit the scope thereof.

What is claimed is:

1. A method for improving processes and outcomes in risk assessment comprising:
performing a risk data analysis procedure to generate at least one best practice;
conducting a best practices training to communicate the risk data analysis procedure and the at least one best practice; and
enabling a quality assurance process that provides monitoring of compliance with the at least one best practice.

2. The method for improving processes and outcomes in risk assessment, as claimed in claim 1, wherein performing the risk data analysis procedure to generate at least one best practice further comprises generating at least one report.

3. The method for improving processes and outcomes in risk assessment, as claimed in claim 1, wherein performing the risk data analysis procedure to generate at least one best practice comprises:
preparing for the risk data analysis procedure;
conducting the risk data analysis procedure to generate at least one quantitative result and at least one qualitative result; and
generating the at least one best practice from the at least one quantitative result and the at least one qualitative result.

4. The method for improving processes and outcomes in risk assessment, as claimed in claim 3, wherein preparing for the risk data analysis procedure comprises:
defining at least one analysis dimension for the risk data analysis procedure;
developing a questionnaire to elicit quantitative analyses;
developing a database to store the at least one quantitative analyses, the at least one quantitative result and the at least one qualitative result; and
selecting a plurality of files from which to conduct the risk data analysis procedure, wherein the plurality of files are defined as a plurality of selected files.

5. The method for improving processes and outcomes in risk assessment, as claimed in claim 4, wherein the at least one analysis dimension comprises one or more analysis dimensions chosen from a group consisting of: type of risk, office, geographic area, resources used in the risk assessment, types of liability, degree of risk, external resources used in the risk assessment, number of claims or defaults made, uniformity of information used, and overlooked exposures.

6. The method for improving processes and outcomes in risk assessment, as claimed in claim 4 wherein developing the questionnaire to elicit quantitative analyses comprises developing a standard questionnaire comprising a plurality of questions designed to elicit quantitative analyses from each of the plurality of selected files, wherein the quantitative analyses may be used to evaluate at least one performance measure in a plurality of risk assessment phases.

7. The method for improving processes and outcomes in risk assessment, as claimed in claim 4, wherein developing a questionnaire to elicit information comprises developing a customized questionnaire comprising customizing a plurality of standard questions designed to elicit quantitative analyses from each of the plurality of selected files, wherein the quantitative analyses may be used to evaluate at least one performance measure in at least one risk assessment phase.

8. The method for improving processes and outcomes in risk assessment, as claimed in claim 6, wherein the at least one risk assessment phase comprises: identifying and evaluating exposure; making a risk decision; setting terms and conditions; setting price and premium; and negotiating.

9. The method for improving processes and outcomes in risk assessment, as claimed in claim 8 wherein the at least one risk assessment phase further comprises setting a service program.

10. The method for improving processes and outcomes in risk assessment, as claimed in claim 4 wherein the database comprises:
a storing portion, wherein the storing portion stores the quantitative analyses, the at least one quantitative result and the at least one qualitative result; and
an analyzing portion, wherein the analyzing portion synthesizes the at least one qualitative result.

11. The method for improving processes and outcomes in risk assessment, as claimed in claim 4, wherein selecting the plurality of files from which to conduct the risk data analysis procedure comprises:
reviewing a plurality of files to identify groups of files with desired properties; and
performing a calibration step to obtain the selected files.

12. The method for improving processes and outcomes in risk assessment, as claimed in claim 11, wherein reviewing a plurality of files to identify groups of files with desired properties further comprises summarizing the groups of files identified with the desired properties in a report.

13. The method for improving processes and outcomes in risk assessment, as claimed in claim 11, wherein the risk assessment is underwriting and wherein reviewing a plurality of files to identify groups of files with desired properties comprises identifying groups of files chosen from among a group comprising: new files, renewal files, files including submissions for coverage wherein the coverage was applied for and quoted but no agreement reached, files including submissions for the coverage wherein the coverage was applied for and denied; and files including submissions to competitors.

14. The method for improving processes and outcomes in risk assessment, as claimed in claim 3, wherein conducting the risk data analysis procedure to generate the at least one quantitative result and the at least one qualitative result comprises:
conducting a quantitative portion of the risk data analysis procedure, wherein the quantitative portion produces the at least one quantitative result; and
conducting a qualitative portion of the risk data analysis procedure, wherein the quantitative portion produces the at least one qualitative result.

15. The method for improving processes and outcomes in risk assessment, as claimed in claim 14, wherein conducting the quantitative portion of the risk data analysis procedure comprises:
training and synchronizing a group of premier risk assessors to analyze a plurality of selected files, wherein the group of premier risk assessors comprises a plurality of members and is a subset of a group of risk assessors; and
having each of the plurality of members of the group of premier risk assessors analyze a subset of the plurality of selected files to produce at least one qualitative analyses.

16. The method for improving processes and outcomes in risk assessment, as claimed in claim 15, wherein training and synchronizing further comprises:
training the group of premier risk assessors as a whole to analyzes the plurality of selected files;
having the group of premier risk assessors as a whole analyze at least one example file;
breaking the group of premier risk assessors into at least two subgroups;
having each subgroup analyze the same new example file, wherein each subgroup prepares an analysis;
comparing the analyses of all the plurality of subgroups to determine if the analyses are consistent;
if the analyses are consistent, breaking the subgroups into smaller subgroups, and repeating having each subgroup analyze the same new example file, wherein each subgroup prepares an analysis and comparing the analyses of all the plurality of subgroups to determine if the analyses are consistent until the subgroups comprise one premier risk assessor.

17. The method for improving processes and outcomes in risk assessment, as claimed in claim 14, wherein conducting the qualitative portion of the risk data analysis procedure, comprises:
conducting interviews with more than one risk assessor; and
conducting focus groups with at least one group of risk assessors, wherein conducting the interviews and focus groups produces at least one qualitative result.

18. The method for improving processes and outcomes in risk assessment, as claimed in claim 3, wherein generating reports from the at least one quantitative result and the at least one qualitative result comprises:
assembling at least one quantitative analysis and the at least one qualitative result in a database;
synthesizing the at least one quantitative result from the at least one quantitative analyses to produce at least one performance measure, wherein the at least one quantitative result is a function of at least one risk assessment phase for each of a plurality of analysis dimensions;
generating at least one recommendation based on the at least one quantitative results; and
generating at least one report based on the at least one quantitative result, the at least one recommendation and the at least one qualitative result.

19. The method for improving processes and outcomes in risk assessment, as claimed in claim 18, wherein at least one risk assessment phase is selected from a group comprising: identifying exposures, evaluating exposures, making a risk assessment decision, setting terms and conditions, setting a price and negotiation.

20. The method for improving processes and outcomes in risk assessment, as claimed in claim 19, wherein the at least one risk assessment phase is selected from a group further comprising: setting a service program.

21. The method for improving processes and outcomes in risk assessment, as claimed in claim 19, wherein the economic gain opportunity is a function of gross leakage.

22. The method for improving processes and outcomes in risk assessment, as claimed in claim 21, wherein the gross leakage is equal to what should have been charge minus what was charged for assuming a risk.

23. The method for improving processes and outcomes in risk assessment, as claimed in claim 22, wherein the net leakage is equal to the gross leakage multiplied by a propensity factor.

24. The method for improving processes and outcomes in risk assessment, as claimed in claim 1, wherein performing the best practices training to communicate the risk data analysis procedure and the at least one report, comprises:
providing hands-on training for best practices;
providing content expert presentations; and
providing networking opportunities.

25. A method for improving processes and outcomes in risk assessment comprising:
performing an risk data analysis procedure to generate at least one best practice, comprising:
preparing for the risk data analysis procedure;
conducting the risk data analysis procedure comprises conducting a quantitative portion to generate at least one quantitative analysis and a qualitative portion to generate at least one qualitative result; and
generating the at least one best practice from the at least one quantitative result and the at least one qualitative result; and
performing a best practices training to communicate the risk data analysis procedure and the at least one best practice, comprising:
providing hands-on training for best practices;
providing content expert presentations; and
providing networking opportunities.

26. The method for improving processes and outcomes in risk assessment, as claimed in claim 25, wherein the risk analysis is underwriting.

27. The method for improving processes and outcomes in risk assessment, as claimed in claim 25, wherein the risk analysis is lending.

28. A computer readable storage medium storing computer readable program code for synthesizing at least one quantitative result for a plurality selected files, the computer readable program code comprising:
data encoding at least one quantitative analyses of the plurality of files;
a computer code implementing a procedure for synthesizing the at least one quantitative result in response to an input of at least one quantitative analyses, wherein the procedure for generating the at least one quantitative result identifies one or more quantitative results for the plurality of files in terms of a plurality of risk dimensions.

29. The computer readable storage medium storing computer readable program code for determining at least one quantitative result, as claimed in claim 28, wherein the computer code generates the quantitative results in terms of at least one performance measure.

30. The computer readable storage medium storing computer readable program code for determining at least one quantitative result, as claimed in claim 28, wherein the performance measure is chosen from among the group consisting of: economic gain opportunity, loss cost avoidance loss cost avoidance and price differential.

31. A computer readable storage medium storing computer readable program code for synthesizing at least one qualitative result for a plurality selected files, the computer readable program code comprising:
data encoding at least one qualitative analysis of the plurality of files;
a computer code implementing a procedure for synthesizing the at least one qualitative result in response to an input of at least one qualitative analysis, wherein the procedure for generating the at least one qualitative result identifies one or more qualitative results for the plurality of files in terms of a plurality of risk dimensions.

32. The computer readable storage medium storing computer readable program code for synthesizing at least one qualitative result for a plurality selected files, as claimed in claim 31, wherein the at least one qualitative result is at least one best practice.

33. A computer readable storage medium storing computer readable program code for determining compliance of a file with at least one best practice, wherein the file comprises a plurality of data, the computer readable program code comprising:
data encoding at least one qualitative analysis of the plurality of files;
a computer code implementing a procedure for determining compliance of a file with at least one best practice in response to an input of the plurality of data, wherein the for determining compliance of a file with at least one best practice identifies compliance by the file of the at least one best practice in terms of a plurality of risk dimensions.

34. A risk analysis device, comprising:
a memory device, wherein the memory device stores at least one quantitative analysis and at least one qualitative result; and
a processor coupled to the memory device, wherein the processor retrieves the at least one quantitative analysis and using the at least one quantitative analysis determines one or more performance measures for a plurality of risk assessment phases.

35. The risk analysis device, as claimed in claim 34, further comprising an input/output device coupled to the processor, wherein the input/output device communicates the at least one quantitative analysis and the at least one qualitative result through the processor to the memory device for storage.

36. A risk analysis device comprising:
a means for performing a risk data analysis process to generate at least one result; and
a means for performing a best practices training to communicate the risk data analysis process and the at least one result.

37. A risk analysis system, comprising:
a risk data analysis preparation procedure, wherein the risk data analysis elicits information from a plurality of files;
a risk analysis device, wherein the risk data analysis device performs a risk data analysis process comprising:
generating at least one result for a plurality of risk dimensions using the information; and
synthesizing the at least one result; and
a best practices training procedure, wherein the best practices training procedure communicates the risk data analysis process and the at least one result.

38. A system for improving processes and outcomes in risk assessment comprising:
a risk analysis device;
a risk analysis software stored in the risk analysis device;
a risk data analysis procedure, implemented in part by the risk analysis device and the risk analysis software, wherein the risk analysis procedure generates reports; and
a method for conducting a best practices training based on the reports.
